(19) United States
(12) Patent Application Publication
(10) Pub. No.: US 2006/0028121 A1
(43) Pub. Date: Feb. 9, 2006

(54) Image display apparatus

(76) Inventors: Junichi Satoh, Yokohama (JP); Fumio Haruna, Yokohama (JP)

Correspondence Address: MCDERMOTT WILL & EMERY LLP, 600 13TH STREET, N.W., WASHINGTON, DC, 20005-3096, US

(21) Appl. No.: 11/065,301

(22) Filed: Feb. 25, 2005

(30) Foreign Application Priority Data
Aug. 4, 2004 (JP) 2004-227418

(51) Int. Cl. H01J 1/62; H01J 63/04

(52) U.S. Cl. 313/496; 313/497

(57) ABSTRACT

An image display apparatus that can keep a high-vacuum level by excellently discharging a residual gas in a space within an FED. The image display apparatus has a cathode substrate on which plural electron emitters that emit electrons are disposed, and an anode substrate having translucency which is disposed opposite to the cathode substrate. The anode substrate has plural phosphors that emit light due to electrons from the electron emitters, and an electrically conductive film that is positioned on the phosphors on the side of the cathode substrate and applied with a high voltage that accelerates electrons from the electron emitters. The conductive film is provided with a getter action that adsorbs a gas within a space defined between the cathode substrate and the anode substrate.

### CLAIM OF PRIORITY

The present application claims priority from Japanese application serial no. P2004-227418, filed on Aug. 4, 2004, the content of which is hereby incorporated by reference into this application.

### BACKGROUND OF THE INVENTION

(1) Field of the Invention

The present invention relates to image display apparatuses such as field emission displays (FED), and more particularly to an image display apparatus configured to satisfactorily increase the vacuum level therein.

(2) Description of the Related Art

The FED includes a cathode substrate on which a plurality of electron emitters, and an anode substrate having phosphors which is disposed opposite to the cathode substrate. Electrons from the electron emitters are allowed to collide with the phosphors, as a result of which the phosphors excitedly emit light to form an image.

In the FED having the above structure, in order to make the electron emission operation of the electron emitters excellent, and in order to lengthen the lifetime of the electron emitters, it is necessary to evacuate gases (oxygen, carbon dioxide, etc.) within a space between the cathode substrate and the anode substrate so as to keep a high-vacuum level in the space. A prior art that satisfies the above requirement is known from Japanese Patent Laid-open No. 2001-351510, for example. The prior art is that getter material such as TiO₂ is added to a black matrix layer for improved contrast to provide the black matrix layer with the getter action.

### SUMMARY OF THE INVENTION

In the above-mentioned Japanese Patent Laid-open No. 2001-351510, the black matrix layer disposed between the plurality of phosphors has the getter action. For that reason, the black matrix layer having the getter action has a small area in contact with the inner space of the FED, and a large getter effect (that is, the exhaust effect of a residual gas within the inner space of the FED) cannot be obtained. Also, the black matrix layer disclosed in Japanese Patent Laid-open No. 2001-351510 has the function of an anodic electrode for allowing the phosphors to excitedly emit light. However, because most of the electrons from the electron emitters are inputted to the phosphors, the amount of electrons that are inputted to the black matrix layer is small. Accordingly, in the structure disclosed in Japanese Patent Laid-open No. 2001-351510, the getter action of the black matrix layer cannot be excellently activated, and from this viewpoint, it is difficult to obtain the large getter effect.

The present invention has been made in view of the problems with the above prior art, and therefore an object of the present invention is to provide an image display apparatus that can keep a high-vacuum level by excellently evacuating the residual gas within the inner space of the FED.

In order to achieve the above object, according to the present invention, there is provided an image display apparatus in which an electrically conductive film is positioned on a plurality of phosphors disposed on an anode substrate (second substrate) on a side of a cathode substrate (first substrate) so as to cover the phosphors, and the conductive film adsorbs a gas within a space defined between the cathode substrate and the anode substrate. That is, the present invention provides the conductive film that is the so-called metal back with a getter action, which is applied with a high voltage for accelerating the electrons from the electron emitters.

In order to provide the conductive film with the getter action, the conductive film may be made of a pure metal selected from the group consisting of Ti, V, Zr, Ta and Nb, an alloy containing the arbitrary combination of the pure metals, a metal oxide of the pure metal or the alloy, or an alloy containing the pure metal and Ba, Al or Ni. Also, the thickness of the conductive film at a position opposite to a portion other than light emission portions of the phosphors may be made thicker than the thickness of the conductive film at a position opposite to the light emission portions of the phosphors. With this structure, the getter action becomes large on that portion.

According to the above structure, because the conductive film that entirely covers the plural phosphors is provided with the getter action, a contact area of a material having the getter action and the FED inner space (that is, a space defined between the cathode substrate and the anode substrate) can be increased. For that reason, the large getter effect can be obtained. Also, because the conductive film is applied with a high voltage for accelerating the electrons from the electron emitters, all or most of electrons from the electron emitters are directed to the conductive film. With this structure, the conductive film is heated by the directed electrons, and the getter action of the conductive film can be excellently activated.

According to the present invention, a high-vacuum level can be kept by excellently discharging the residual gas within the FED inner space.

### BRIEF DESCRIPTION OF THE DRAWINGS

These and other objects and advantages of this invention will become more fully apparent from the following detailed description taken with the accompanying drawings in which:

FIG. 1 is a diagram showing an image display apparatus according to a first embodiment of the present invention;

FIG. 2 is a diagram showing an image display apparatus according to a second embodiment of the present invention;

FIG. 3 is a diagram for explaining the arrangement of phosphors of an FED;

FIG. 4 is a diagram for explaining the effects of the second embodiment; and

FIG. 5 is a diagram showing a structural example of a circuit block of an image display apparatus to which the present invention is applied.

### DETAILED DESCRIPTION OF THE PREFERRED EMBODIMENT

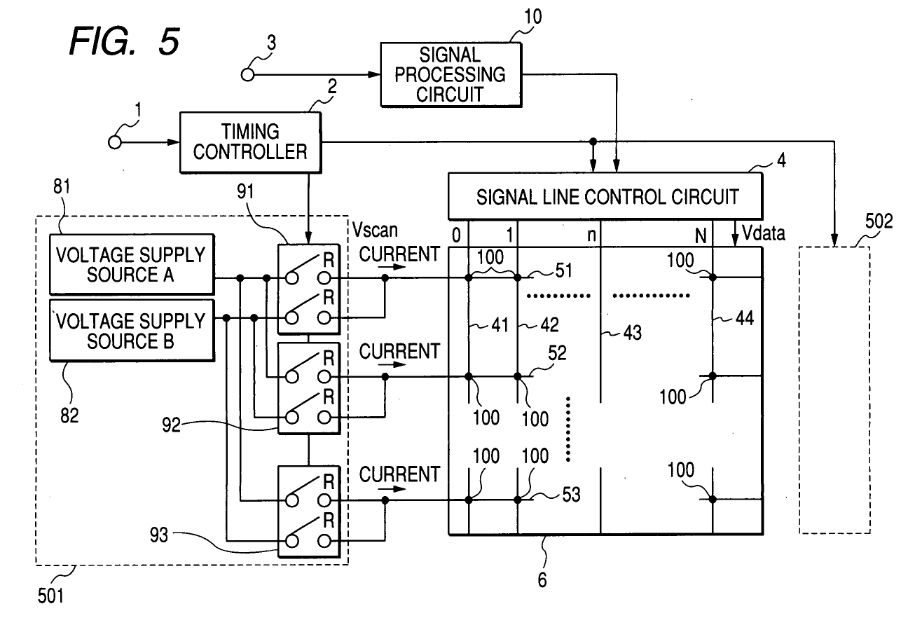

Hereinafter, a description will be given in more detail of preferred embodiments of the present invention with reference to the accompanying drawings. First, a structural example of a circuit block of an image display apparatus to which the present invention is applied will be described with reference to FIG. 5. In this embodiment, the FED of the passive matrix drive system having an MIN (metal insulator metal) electron source is exemplified as the electron emitters. However, the present invention can be applied to electron sources other than the MIN, for example, an SCE electron source or a carbon nano tube electron source.

A video signal is inputted to a video signal input terminal 3, and then supplied to a signal processor circuit 10. In the signal processor circuit 10, the video signal is subjected to a variety of given signal processing such as γ correction, color correction and contrast correction.

A horizontal synchronous signal corresponding to the input video signal is inputted to a horizontal synchronous signal input terminal 1, and supplied to a timing controller 2. In the timing controller 2, a timing pulse that is synchronous with the horizontal synchronous signal is generated and then supplied to scanning line control circuits 501 and 502.

On the other hand, a display panel 6 has a plurality of scanning lines 51 to 53 that extend horizontally on a screen (lateral direction on the paper surface) and that are arranged in parallel in the vertical direction of the screen (longitudinal direction on the paper surface). In addition, a plurality of signal lines 41 to 44 that extend in the vertical direction on the screen (longitudinal direction on the paper surface) are arranged in parallel in the horizontal direction on the screen (lateral direction on the paper surface). Those scanning lines 51 to 53 and signal lines 41 to 44 are orthogonal to each other, and electron emitters 100 that are connected with the respective scanning lines and the respective signal lines are arranged at the respective cross points. With this structure, the plural electron emitters 100 are arranged in a matrix. The scanning lines 51 to 53, the signal lines 41 to 44 and the electron emitters 100 are formed on a cathode substrate or a first substrate, which will be described later.

Both ends of the scanning lines 51 to 53 in the lateral direction are connected with scanning line control circuits 501 and 502, respectively. The scanning line control circuits 501 and 502 apply a scanning voltage (Vscan) for selecting one or two scanning lines from the scanning lines 51 to 53 to the scanning lines 51 to 53 in synchronism with a timing pulse from the timing controller 2. That is, the scanning line control circuits 501 and 502 sequentially apply the scanning voltage of horizontal synchronization to the scanning lines 51 to 53, to thereby select the electron sources of one or two lines in the order from the above in a horizontal cycle, thus performing vertical scanning operation.

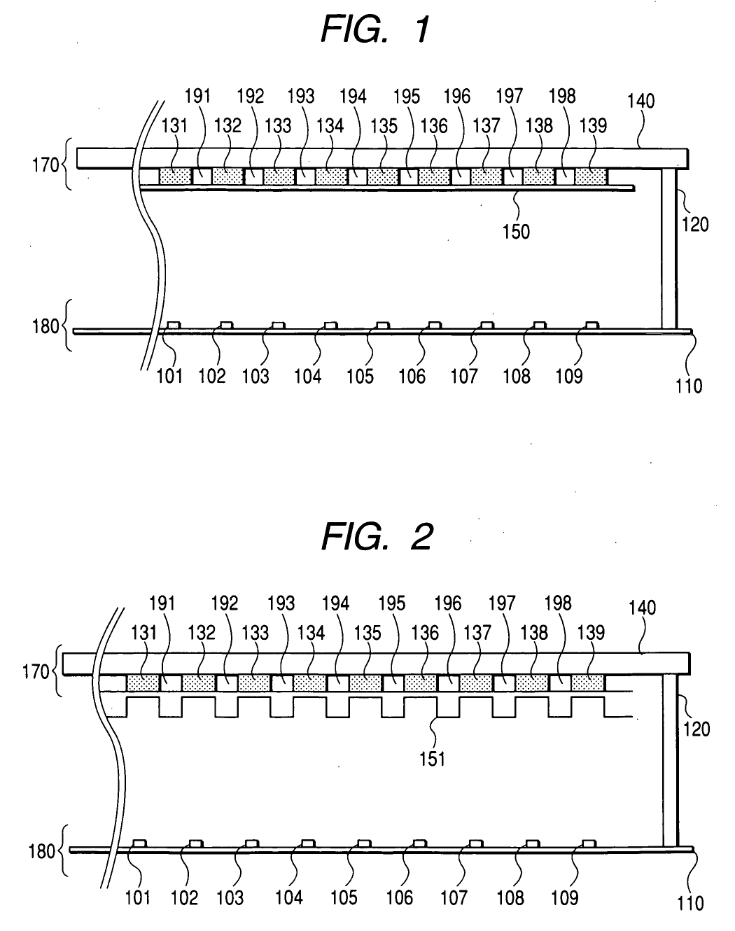

The scanning line control circuits 501 and 502 includes a voltage supply source A81 that applies a selected potential (for example, 5 V or −5 V), a voltage supply source B82 that applies an unselected potential (for example, 0 V), and switch circuits 91 to 93. The switch circuits 91 to 93 are connected to the scanning lines 51 to 53, respectively. Then, the switch circuits 91 to 93 perform the following switching operation in response to the timing pulse from the timing controller 2. The selected potential from the voltage supply source A81 is applied to a corresponding scanning line in a case of selecting the corresponding scanning line. In addition, the unselected potential from the voltage supply source B82 is applied to the scanning lines in other cases. That is, the scanning voltage Vscan is developed by switching over the selected potential and the unselected potential through the switch circuits 91 to 93. In FIG. 1, for simplification, only the inner structure of the scanning line control circuit 501 is shown, but the scanning line control circuit 502 also has the same structure. Also, the scanning line control circuits 501 and 502 may be alternately switched over every scanning line for activation, or may be alternately switched over every frame for activation. In addition, when one scanning line is selected, the two scanning line control circuits 501 and 502 are driven at the same time to apply the scanning voltage to one scanning line at the same time. Furthermore, only any one of the scanning line control circuits 5901 and 502 may be used.

The upper ends of the signal lines 41 to 44 are connected with a signal line control circuit 4 or a driving voltage supply circuit. The signal line control circuit 4 generates driving signals (Vdata) corresponding to the respective signal lines (electron emitters) on the basis of a video signal that is supplied from a signal processor circuit, and then supplies the driving signals to the respective signal lines.

When the driving voltage from the signal line control circuit 4 is applied to the associated electron emitter connected to the scanning line selected by the scanning voltage, a potential difference between the scanning voltage and the driving voltage is applied to the associated electron emitter. When the potential difference exceeds a given threshold value, the electron source discharges the electrons. The amount of electrons discharged from the electron source is substantially proportional to the potential difference when the potential difference is equal to or greater than the threshold value. In the case where the driving voltage is positive, the scanning voltage becomes negative whereas the driving voltage is negative, the scanning voltage becomes positive. Also, an anode substrate or a second substrate, which will be described later, is disposed opposite to the cathode substrate. A space is defined between the cathode substrate and the anode substrate, and a vacuum atmosphere is created in the space. Phosphors, which will be described later, are disposed on a surface of the anode substrate which faces the cathode substrate at positions opposite to the respective electron emitters. In addition, an electrically conductive film which forms a metal back to be applied with a high voltage is formed on the phosphors. The electrons emitted from the electron emitters are accelerated by a high voltage applied to the conductive film. The electrons are then advanced and collide with the phosphors. As a result, the phosphors excitedly emit light, and the emitted light passes through a transparent glass that structures the anode substrate, which will be described later, and is then discharged to the external. With the above operation, an image is formed on a display surface of the FED.

### First Embodiment

A first embodiment of the present invention will be described with reference to FIG. 1. FIG. 1 is a side view showing a section of the display panel 6 shown in FIG. 5. A cathode substrate 180 or a first substrate includes a rear glass 110, on which a plurality of electron emitters 101 to 109 are formed. In FIG. 1, the scanning lines 51 to 53 and the signal lines 41 to 44 shown in FIG. 5 are omitted from the drawing. On the other hand, an anode substrate 170 or a second substrate includes a front glass 140 having translucency, and phosphors 131 to 139 are disposed on a surface of the front glass 140 which faces the cathode substrate 180. The phosphors 131 to 139 are disposed at positions corresponding to the electron emitters 101 to 109 on the cathode substrate 180, respectively. Then, an electrically conductive film 160 or a metal back mainly made of metal is disposed on the side of the cathode substrate 180 of the phosphors 131 to 139. The conductive film 150 entirely covers the phosphors 131 to 139, and a high voltage (e.g., 1 to 5 kV) for accelerating the electrons emitted from the electron emitters 101 to 109 is applied to the conductive film 150 as described above. The electrons that have been accelerated by the high voltage are directed to the conductive film 150, pass through the conductive film 150, and collide with the phosphors 131 to 192. As a result, the phosphors 131 to 139 excitedly emit light. Non-emission portions are disposed between each phosphor 131 to 139, and black matrixes 191 to 198 are disposed on the respective non-emission portions. The black matrixes 191 to 198 have a function of absorbing outside light that is inputted from the display surface of the anode substrate 170 (in FIG. 1, the upper surface of the anode substrate 170) and improving contrast (that is, a reduction in mirroring on the display surface of the anode substrate 170). In FIG. 1, the number of the electron emitters and the number of phosphors are each 9. However, it is needless to say that the actual numbers of electron emitters and phosphors are increased more than 9.

As described above, to define the space between the cathode substrate 180 and the anode substrate 170, spacers 120 for supporting the cathode substrate 180 and the anode substrate 170 are disposed. In order to make the electron emitting operation of the electron emitters 101 to 109 excellent, and in order to lengthen the lifetime of the electron emitters, it is necessary that the high degree of vacuum is kept in the space. For that reason, according to the present invention, the conductive film 150 is provided with the getter action so that the conductive film 150 in contact with the gas within the space may adsorb the gas (for example, oxygen, carbon dioxide, etc.) within the space.

In order to provide the conductive film 150 with the getter action, in this embodiment, the conductive film 150 may be made of a pure metal selected from the group consisting of, e.g., Ti, V, Zr, Ta and Nb, the alloy thereof, a metal oxide of the pure metal or the alloy thereof, or an alloy containing the pure metal and Ba, Al or Ni. The metal such as Ti, V, Zr, Ta and Nb is small in the amount of gas discharged from those metals, and those metals per se have the getter action. When the conductive film 150 is made of the above materials, the gas within the space can be adsorbed, and the high-vacuum level can be maintained without an element having the getter action being additionally disposed within the space.

Also, since the conductive film 150 receives and transmits the electrons from the electron emitters 101 to 109 with application of a high voltage, the electrons can activate the getter action of the conductive film 150. That is, when the conductive film 150 transmits the electrons from the electron emitters 101 to 109, a loss of energy provided in the electrons occurs, and the loss is converted into thermal energy to heat the conductive film. When the conductive film is heated, the getter action of the conductive film 150 is activated to promote the gas adsorption of the conductive film 150. That is, according to the structure of this embodiment, in the operation of the FED where a gas such as oxygen or carbon dioxide is liable to occur (that is, during display of an image) the getter action is enhanced, and more gas adsorption can be conducted.

Also, the amount of discharged gas of Al which is generally used as a material of the conductive film 150 is roughly larger than that of a pure metal selected from the group consisting of Ti, V, Zr, Ta and Nb, the alloy thereof, a metal oxide of the pure metal or the alloy thereof, or an alloy containing the pure metal and Ba, Al or Ni. For example, reference document 1 “Industrial technology research promotion business report, Project ID: 00B68011d” has reported that Ti that has been subjected to surface treatment greatly reduced the amount of discharged gas. When the above-mentioned material that is small in the amount of discharged gas is used for the conductive film 150 that heats by absorbing the electron energy, an effect of keeping the clean vacuum atmosphere can also be expected.

### Second Embodiment

A second embodiment of the present invention will next be described with reference to FIG. 2. In FIG. 2, the same symbols as those in FIG. 1 have the identical functions. This embodiment is characterized in that in the conductive film 152 portions located at the non-emission portions between each phosphor 131 to 139, that is, at respective positions corresponding to the black matrixes 191 to 198 are formed to project toward the cathode substrate side. That is, the conductive film 151 according to this embodiment is thinner in thickness at first positions corresponding to the phosphors 131 to 139, and thicker at second positions corresponding to the black matrixes 191 to 198 than at the first positions. A material of the conductive film 151 is the same as that described in the first embodiment, and the conductive film 151 has the same getter action as that of the conductive film 150.

The electrons emitted from the electron emitters 101 to 109 lose their energy while the electrons are penetrating through the conductive film 151. Therefore, in order to allow the phosphors 131 to 139 to sufficiently emit light, it is preferable to thin the conductive film 151 at the portions corresponding to the first positions. On the other hand, the getter effect becomes higher as the volume of the metal film 151 is larger. According to this embodiment, in order to obtain the high getter effect while allowing the phosphors 131 to 139 to sufficiently emit light, the thickness of the conductive film 151 at the first positions corresponding to the phosphors 131 to 139 is thinner, whereas the thickness of the conductive film 151 at the second positions corresponding to the black matrixes 191 to 198 is thicker than the thickness at the first positions as described above. With the above structure, since the thickness of the conductive film 161 is reduced at the first positions thereof, the conductive film 141 sufficiently transmits the electrons at the portions. Also, since the thickness of the conductive film 151 is increased at the second positions thereof, the conductive film 151 at those portions becomes large in the volume, thereby making it possible to enhance the getter effect. Hereinafter, the respective preferred thicknesses of the conductive film 151 at the first position and the second position will be described.

The energy that is lost by the electrons in the conductive film is obtained from the following expression 1 with reference to, for example, Reference document 2, “whiddington”, the transmission of cathode rays through matter, Proc. Roy. Soc. London B58, 912, P556.

$$E = {{E}_{0} ( 1 - \frac{x}{R} )}^{\frac{1}{2}} \qquad Expression 1$$

In expression 1, x is the depth of implantation of electrons into the metal film, E is an energy with a depth x of electrons inputted into the conductive film, E₀ is an initial energy of the electrons inputted into the conductive film, and R is the depth of implantation of electrons into the metal film when the energy of the inputted electrons becomes 0. Also, R is given by the following expression 2 with reference to the above reference document 2.

$$R = 25 ( \frac{A}{ρ} ) {( \frac{{E}_{0}}{{Z}^{\frac{1}{2}}} )}^{n} \\ where n = \frac{1.2}{( 1 - 0.29 {log}_{10} Z )} \qquad Expression 2$$

In expression 2, ρ is a solid density of a material that makes up the conductive film, A is a molecular weight of the material that makes up the conductive film, and Z is an atomic number of the material that makes up the conductive film.

If R is calculated by using the expression 2 under the condition where the initial energy E₀ is 5 keV, R becomes, for example, about 300 nm when the conductive film is made of Ti, about 206 nm when Zr, and about 67 nm when Ta. It is necessary to set the thickness of the first position of the conductive film to a value equal to or lower than R obtained from the above expression 2 although depending on the magnitude of the initial energy E₀. Also, if the thickness of the conductive film is R/2, an energy of the electrons which is lost by the conductive film is about 30% of the initial energy. Likewise, when the thickness of the metal film is 7R/10, about 50% of the initial energy is lost. In view of the above fact, it is preferable that the thickness of the conductive film at the first position is 7R/10 or less where the half or more of the initial energy can be used for light emission. In the case where the mixture of plural materials is used for the conductive film, the molecular weight A and the atomic number S are obtained by weighting the monocular weights A and the atomic numbers S of the materials according to the mixture ratio of the materials and averaging them. For example, in the case where the conductive film is made of an alloy consisting of a material C and a material D mixed together at a ratio of 1:2, the molecular weight AC and the atomic number SC of the material C are weighted by ⅓, the molecular weight AD and the atomic number SD of the material D are weighted by ⅔. Then, the molecular weights are added to each other and the atomic numbers are added to each other, thus, providing the molecular weight and the atomic number.

It is preferable that a relationship between the thickness of the conductive film 151 at the first position and the thickness of the conductive film 151 at the second position satisfy 10·L1<L2 assuming that the thickness of the conductive film 151 at the first position is L1, and the thickness of the conductive film 151 at the second position is L2. For example, when L is about 100 nm, L2 becomes 1 μm or more.

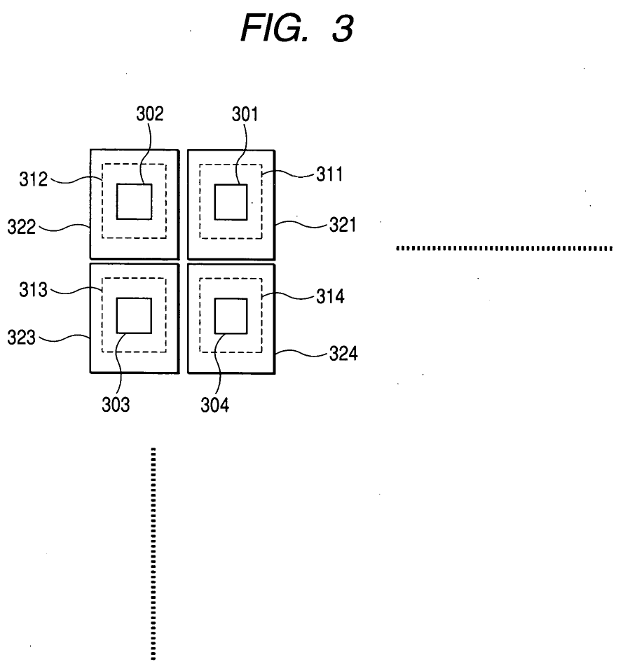

FIG. 3 is a diagram for explaining the arrangement of the phosphors. Rectangular light emission portions 301 to 304 are formed by providing black matrixes 311 to 314 on phosphor coated-portions 321 to 324, respectively. It is unnecessary to penetrate electrons in areas other than the light emission portions 301 to 304. Therefore, the thickness of the conductive film in the areas other than the light emission portions 301 to 304 can be thickened to R or more obtained by the above expression. For that reason, the capacity of the getter of the conductive film at those portions can be increased. When the film thickness is too thick, there arises such drawbacks that electron orbits are curved, or arcing occurs between the anode substrate and the cathode substrate at portions where the film thickness is thick. As a result, the upper limit of the thickness of the conductive film is set. It is preferable that the upper limit of the film thickness be set to a level substantially equal to the lateral dimension or longitudinal dimension of the light emission portion of the phosphors, although depending on the magnitude of a voltage that is applied to the conductive film.

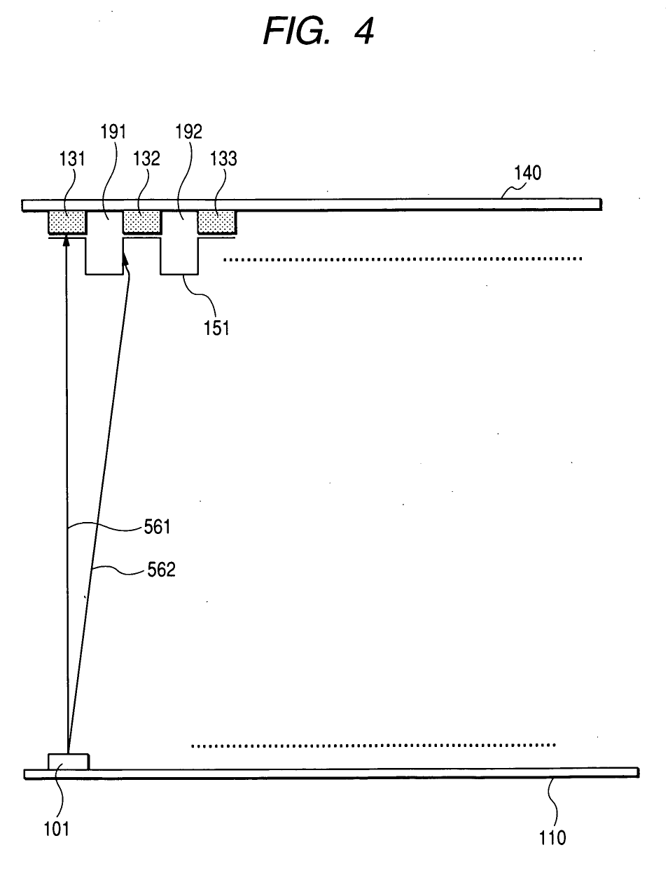

FIG. 4 shows electron orbits when the thickness of the conductive film 151 is varied depending on the portions as shown in FIG. 2. In FIG. 4, the same symbols as those in FIG. 2 have the identical function. Also, in FIG. 4, an electron orbit 561 represents an orbit in the case where correct image formation is formed on the light emission side surface of a front glass 140 (a surface opposite to a surface on which phosphors 131 to 133 are formed). In addition, an electron orbit 562 represents an orbit in the case where electrons are directed to an adjacent pixel due to the expansion of the electron beams.

The thickness of the conductive film 151 at the second portion (that is, a protrusion toward the cathode substrate 180 (the rear glass 110) may be set to a level substantially equal to the lateral dimension or the longitudinal direction of the light emission portion of the phosphors. In this case, the electric field gradient provided by the conductive film 151 ensures an orbit perpendicularly incident on the fluorescent surface as with the electron orbit 561. Also, the increased thickness of the conductive film at the above second portion allows the electrons directed to the adjacent pixel due to the expansion of the electron beams to get close to a corner of the portion where the conductive film 151 is thick as indicated by the electron orbit 562 shown in FIG. 4. For that reason, the electrons that are directed to the adjacent pixel are attracted to the conductive film by the electric field of the second portion of the conductive film 161 as indicated by the electron orbit 562, and do not arrive at the adjacent pixel. Therefore, according to the structure of the second embodiment, the getter effect can be enhanced, and the effect of preventing the light emission error due to the expansion of the electron beams can be expected.

As described above, according to the present invention, the conductive film (metal back) to which a high voltage for accelerating electrons is applied is made of a material that has the getter effect and is small in the gas discharge. With this structure, the residual gas within the FED can be reduced. As a result, there can be provided an image forming apparatus that reduces a drawback such as the deterioration of the electron emitter due to the residual gas and is small in luminance variation.

The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

What is claimed is:

1. An image display apparatus, comprising:
a first substrate on which a plurality of electron emitters that emit electrons are disposed; and
a second substrate having translucency which is disposed opposite to the first substrate;
wherein the second substrate includes:
a plurality of phosphors that are disposed on a surface opposite to the first substrate and emit light by electrons from the electron emitters; and
an electrically conductive film that is located on the phosphors on a side of the first substrate and applied with a high voltage to accelerate the electrons emitted from the electron emitters; and
wherein the conductive film is disposed at a position where the conductive film is in contact with a gas within a space defined between the first substrate and the second substrate, and adsorbs the gas within the space.

2. The image display apparatus according to claim 1, wherein the conductive film is formed to cover the plurality of phosphors within the space defined between the first substrate and the second substrate.

3. The image display apparatus according to claim 2, wherein the conductive film transmits the electrons from the electron emitters and ejects the electrons into the phosphors.

4. The image display apparatus according to claim 2, wherein the conductive film is made of a pure metal selected from the group consisting of Ti, V, Zr, Ta and Nb, an alloy containing the arbitrary combination of the pure metals, a metal oxide of the pure metal or the alloy, or an alloy containing the pure metal and Ba, Al or Ni.

5. The image display apparatus according to claim 2, wherein the thickness of the conductive film at a position opposite to a portion other than light emission portions of the phosphors is thicker than the thickness of the conductive film at a position opposite to the light emission portions of the phosphors.

6. An image display apparatus, comprising:
a first substrate on which a plurality of electron emitters that emit electrons are disposed; and
a second substrate having translucency which is disposed opposite to the first substrate;
wherein the second substrate includes:
a plurality of phosphors that are disposed on a surface thereof opposite to the first substrate so as to correspond to the respective electron emitters; and
an electrically conductive film that is located on the phosphors on a side of the first substrate, formed to cover the plurality of phosphors, and applied with a high voltage so as to accelerate the electrons emitted from the electron emitters; and
wherein the conductive film is disposed at a position where the conductive film is in contact with a gas within a space defined between the first substrate and the second substrate, and has a getter action.

7. The image display apparatus according to claim 6, wherein the conductive film has the getter action activated by the electrons from the electron emitters.

8. The image display apparatus according to claim 6, wherein the thickness of the conductive film at a first position opposite to a portion other than light emission portions of the phosphors is thicker than the thickness of the conductive film at a second position opposite to the light emission portions of the phosphors so that a getter effect of the conductive film at the first position is larger than the conductive film at the first position.

9. An image display apparatus, comprising:
a first substrate on which a plurality of electron emitters that emit electrons are disposed; and
a second substrate having translucency which is disposed opposite to the first substrate;
wherein the second substrate includes:
a plurality of phosphors that are disposed on a surface thereof opposite to the first substrate so as to correspond to the respective electron emitters; and
an electrically conductive film that is located on the phosphors on a side of the first substrate, formed to cover the plurality of phosphors, and applied with a high voltage so as to accelerate the electrons emitted from the electron emitters; and
wherein the conductive film is disposed at a position where the conductive film is in contact with a gas within a space defined between the first substrate and the second substrate, and is made of a pure metal selected from a group consisting of Ti, V, Zr, Ta and Nb, an alloy containing the arbitrary combination of the pure metals, a metal oxide of the pure metal or the alloy, or an alloy containing the pure metal and Ba, Al or Ni.

10. The image display apparatus according to claim 9, wherein the thickness of the conductive film at a first position opposite to a portion other than light emission portions of the phosphors is thicker than the thickness of the conductive film at a second position opposite to the light emission portions of the phosphors.

11. The image display apparatus according to claim 10, wherein the thickness of the conductive film at the first position is R or less obtained through the following expression 2, and the thickness of the conductive film at the second position is R or more,
$$R = 25 ( \frac{A}{ρ} ) {( \frac{{E}_{0}}{{Z}^{\frac{1}{2}}} )}^{n} \\ where n = \frac{1.2}{( 1 - 0.29 {log}_{10} Z )} , \qquad Expression 2$$
where in the expression 2, ρ is a fixed density of a material that makes up the conductive film, A is a monocular weight of the material that makes up the conductive film, Z is an atomic number of the material that makes up the conductive film, and E₀ is an initial energy of the electrons that are inputted into the conductive film.

12. An image display apparatus, comprising:
a first substrate on which a plurality of electron emitters that emit electrons are disposed; and
a second substrate having translucency which is disposed opposite to the first substrate;
wherein the second substrate includes:
a plurality of phosphors that are disposed on a surface opposite to the first substrate and emit light by electrons from the electron emitters; and
an electrically conductive film that is located on the phosphors on a side of the first substrate and applied with a high voltage to accelerate the electrons emitted from the electron emitters; and
wherein the thickness of the conductive film at a first position opposite to portions other than the light emission portion of the phosphors is thicker than the thickness of the conductive film at a second position opposite to the light emission portion of the phosphors.

13. The image display apparatus according to claim 10, wherein the conductive film at the first position is formed to protrude toward the first substrate.
